(19) United States
(12) Patent Application Publication
(10) Pub. No.: US 2015/0120132 A1
(43) Pub. Date: Apr. 30, 2015

(54) System And Method To Instrument And Gather Three-Dimensional (3-D) Vehicle Tracking And Operating Information

(71) Applicants: Mark Kramer, Castle Rock, CO (US); Wilfred Tucker, Centennial, CO (US); John Sample, Centennial, CO (US)

(72) Inventors: Mark Kramer, Castle Rock, CO (US); Wilfred Tucker, Centennial, CO (US); John Sample, Centennial, CO (US)

(21) Appl. No.: 14/589,557

(22) Filed: Jan. 5, 2015

Related U.S. Application Data
(63) Continuation-in-part of application No. 13/934,979, filed on Jul. 3, 2013.
(60) Provisional application No. 61/668,069, filed on Jul. 5, 2012.

(51) Int. Cl. G07C 5/00; G01S 19/13

(52) U.S. Cl. CPC G07C 5/008; G01S 19/13
USPC 701/31.4

(57) ABSTRACT

A vehicle monitoring system and method of monitoring a vehicle has, in part, a monitoring device which couples to a vehicle by way of a cigarette adapter, universal serial bus port, or the like. Once coupled to the vehicle, the device draws and in some cases stored power from the vehicle's battery. The monitoring device contains a variety of sensing components including an accelerometer, transceivers, gyroscopes, thermometers, light sensors, and carbon dioxide sensors. These components take measurements based on the vehicle's movements and interoperability between working parts. This information is collected and sent via wireless connection to a compatible wireless device such as a smart phone. The information can then be sent to a remote web server and/or uploaded into different interpretive software including mapping software. The vehicle can then be maintained or serviced in a manner consistent with the needs identified from the data collected by the monitoring device.

### CLAIM OF PRIORITY

This application is a continuation in part of U.S. application Ser. No. 13/934,979 filed on Jul. 3, 2013 which claims priority to U.S. Application 61/668,069 filed on Jul. 5, 2012, the contents of both of which are herein fully incorporated by reference in their entirety.

### FIELD OF THE EMBODIMENTS

The field of invention relates to systems and methods for monitoring vehicle status and the behavior of the driver or operator of the vehicle. In particular, using wireless technology to inexpensively retrofit heavy duty vehicles with a monitoring device capable of communicating with a number of wireless devices and wireless protocols.

### BACKGROUND OF THE EMBODIMENTS

The implementation of user driven motor vehicles or automobiles has created an environment upon which we as a society have come heavily to rely. Over the years, innumerable safety features have been added or improved upon including safety belts, warning lights, alarms, and various structural designs. A new, emerging safety feature market is that of vehicular monitoring and tracking. This has become popular with parents of new teen drivers as a way to monitor their behavior and to discuss driving safely. Further, some insurance companies offer such monitoring as a way of reducing premiums and helping to ensure safe driving.

However, such monitoring can also be helpful for not only creating safer drivers, but also in monitoring the operational state of the vehicle. For example, a driver may not know their brakes are not functioning correctly and overheating when being used. This could lead to damage to the automobile or catastrophic brake failure. Such incidents could be limited or prevented with a more comprehensive, yet inexpensive monitoring apparatus.

In vehicle monitoring, some monitorable features include driver behavior (speed, hard braking), fuel consumption, vehicle diagnostics, and location tracking. Existing systems have limitations to their use and practicality. For example, one such limitation is that existing systems collect data from a plethora of sensors and/or the built-in vehicular instrumentation. This can result in mass quantities of information that is expensive to collect if the same methodology is applied to other vehicles. However, this data cannot necessarily be interpreted and collected by an individual.

Typically, such monitoring occurs in a vehicle and manifests itself as a warning light such as a check engine light. The driver must then take in the automobile to a mechanic where the mechanic can read an error code via the automobile's on-board diagnostic port or OBD port. A computer rather than the mechanic typically interprets the error code and the appropriate fix can then be applied. Thus, a driver does not know the true cause of the issue nor can they ascertain and attempt to cure the issue themselves without the purchase of additional expensive equipment.

Additionally, as stated above, the on-board diagnostics port on passenger cars and light trucks serves to supply various data points pertinent to use and focuses primarily on engine performance not vehicle position, diver behavior, or location tracking. Further, and more concerning, is these ports are not necessarily present on heavy, industrial and commercial trucks and other such vehicles. Thus, the fixing or remedying of issues with such automobiles becomes even more problematic and often more expensive. The absence of these ports creates the need for a simple solution to monitor similar information while keeping costs to a minimum. Further, the data should be easy to interpret such that any individual can understand the implication of various data.

Review of related technology:

U.S. Pat. No. 8,120,473 pertains to a method and system in which maintenance vehicles collect information from sensors and operators, forward the collected information to a server, and, in response, receive maps and operator instructions.

U.S. Pat. No. 8,010,251 pertains to a management system using global positioning system receivers for tracking remote units from a central office and quickly and conveniently determining if those remote units have varied from a set of predetermined parameters of operation. The system also includes provisions that allows information to be sent from the remote units to the central office and vice versa. The system also has safety features that promote the rapid dispatch of law enforcement personnel when requests for emergency assistance have been made from the remote units.

U.S. Pat. No. 7,421,344 pertains to an on-board intelligent vehicle system that includes a sensor assembly to collect data and a processor to process the data to determine the occurrence of at least one event. The data may be collected from existing standard equipment such as the vehicle communication bus or add-on sensors. The data may be indicative of conditions relating to the vehicle, roadway infrastructure, and roadway utilization, such as vehicle performance, roadway design, roadway conditions, and traffic levels. The detection of an event may signify abnormal, substandard, or unacceptable conditions prevailing in the roadway, vehicle, or traffic. The vehicle transmits an event indicator and correlated vehicle location data to a central facility for further management of the information. The central facility sends communications reflecting event occurrence to various relevant or interested users. The user population can include other vehicle subscribers (e.g., to provide rerouting data based on location-relevant roadway or traffic events), roadway maintenance crews, vehicle manufacturers, and governmental agencies (e.g., transportation authorities, law enforcement, and legislative bodies).

U.S. Patent Application 2012/0109692 pertains to a system where vehicle insurance customers select parameters and/or preferences for monitoring using one or more telematics devices. The parameters and/or preferences may comprise an operating characteristic associated with at least one vehicle associated with a personal insurance product. Selection and measurement of parameters and/or preferences may result in lower insurance premiums. In one embodiment, an apparatus causes, based on a user selection of at least one of a plurality of menu-selectable options, a remotely programmable memory of at least one monitoring device to store an indication of the monitoring parameters and/or preferences represented by the user selection.

Various devices are known in the art. However, their structure and means of operation are substantially different from the present disclosure. The present invention and its embodiments can be retrofit to any type of user controlled vehicle, namely heavy duty vehicles. The other inventions also fail to solve all the problems taught by the present disclosure. By providing a simple and inexpensive solution to vehicle monitoring, especially in those vehicles that lack an on board diagnostics port, the present invention rises above any known art. At least one embodiment of this invention is presented in the drawings below and will be described in more detail herein.

### SUMMARY OF THE EMBODIMENTS

The invention is generally a method and system to monitor and recreate the path of a vehicle through augmented video in order to assess and diagnose vehicle health and driver behavior. In creating this system, the inventor has found a way to simply and inexpensively create such a monitoring system. Further, this system can be used an all types of vehicles since, unlike much of the known art, no on-board diagnostics ports is required for data collection.

Additionally, by enabling a monitoring apparatus with ingrained logic and capable of real time data collection and transmittal, any layperson can understand what issues their vehicle may be experiencing before having to take the vehicle to be serviced by a mechanic. The data can be viewed and alerts generated on a wireless device such as a cellular phone or smart phone. This clean interface removes complex codes that must be interpreted by a mechanic's expensive equipment and knowledge to allow any individual to understand how to solve a particular problem with a vehicle.

Further, the usage of augmented video creates a three-dimensional (x, y, z axis) visual representation of the vehicle from the collected data. This allows for visual inspection of the vehicle health to determine how the vehicle responds to certain conditions (i.e. hills, corners) or how it is being driven by the occupant. For example, using the internal GPS one may be able to see if the vehicle came to a complete stop at a known stop sign located at an intersection and other various behaviors that may otherwise go undiscovered.

According to one embodiment of the present invention there a monitoring system for a vehicle capable of being user controlled, the monitoring system having a monitoring apparatus operably connected to the vehicle, the monitoring apparatus having a digital compass, digital accelerometer, digital gyroscope, global positioning system and at least one environmental sensor, wherein the at least one environmental sensor consists of a carbon dioxide, temperature, humidity, or light sensor, or any combination thereof, wherein the vehicle lacks an on-board diagnostics port; and a wireless device having wireless communication capabilities contained within a predetermined proximity to the monitoring apparatus, wherein the wireless device establishes a wireless connection with the monitoring apparatus.

In another embodiment of the present invention there is a monitoring system for a vehicle capable of being user controlled, the monitoring system having a monitoring apparatus operably connected to the vehicle, the monitoring apparatus having a plurality of sensors, wherein the vehicle lacks an on-board diagnostics port; a cellular phone having wireless communication capabilities contained within a predetermined proximity to the monitoring apparatus, wherein the cellular phone establishes a wireless connection with the monitoring apparatus; and wherein the monitoring system changes the operative state of load bearing electronics by monitoring direct current voltage load changes of at least one battery of the vehicle.

In some embodiments, the Bluetooth® compatible device may have also Wi-Fi capabilities or both. The monitoring apparatus has a plurality of digital sensors including but not limited to a digital compass, digital accelerometer, digital gyroscope, global positioning system, and at least one sensor. The environmental sensors may vary but may comprise, but not limited to, any number of humidity sensors, carbon dioxide sensors, light sensors, temperature sensors, and sound sensors. The Bluetooth® compatible device must be within an operable range in relation to the monitoring apparatus.

The monitoring system may draw power from the vehicle and in some instances be able to harvest that power for use when the vehicle is in the “off” state. The monitoring system achieves this by either plugging into a cigarette adapter in the vehicle or in a universal serial bus port, if present, within the vehicle. The Bluetooth® compatible wireless device may take the form of a smart phone, laptop, PC, PDA, smart watch, or the like. Additionally, the wireless device may act as a gateway and forward the collected data to a remote web server.

In another aspect of the present invention there is a method of monitoring a heavy duty vehicle employing a monitoring system, the method having the steps of removably coupling a monitoring system to the heavy duty vehicle forming an operable connection between the monitoring system and the heavy duty vehicle, wherein the heavy duty vehicle lacks an on-board diagnostics port, and wherein the monitoring system comprises a plurality of sensors, a monitoring apparatus having a digital compass, digital accelerometer, digital gyroscope, global positioning system and at least one environmental sensor, wherein the at least one environmental sensor consists of a carbon dioxide, temperature, humidity, or light sensor, or any combination thereof, and a wireless device having wireless communication capabilities contained within a predetermined proximity to the monitoring apparatus, wherein the wireless device establishes a wireless connection with the monitoring apparatus; collecting data in real time from the plurality of sensors associated with the monitoring system configured to monitor vehicular operations, wherein the monitoring system changes the operative state of load bearing electronics of the heavy duty vehicle by monitoring and logging direct current voltage load changes of at least one battery of the heavy duty vehicle; sending the collected data from the monitoring apparatus to a wireless device, the wireless device being capable of receiving an electronic signal from the monitoring apparatus; interpreting the collected data on the wireless device or a separate wireless device via a three dimensional recreation of the traveled path of the heavy duty vehicle, wherein the collected data is interpreted using three dimensional mapping software; and assessing the operable condition of the heavy duty vehicle by comparing the collected data to predetermined standards for the heavy duty vehicle.

In general, the present invention succeeds in conferring the following, and others not mentioned, benefits and objectives.

It is an object of the present invention to provide a vehicle monitoring system that is simple to use and inexpensive.

It is an object of the present invention to provide a vehicle monitoring system that can be retrofit into most any existing vehicle.

It is an object of the present invention to provide a vehicle monitoring system that monitors a plurality of sensors and the like operably coupled to the vehicle. It is an object of the present invention to provide a vehicle monitoring system that draws power from the vehicle's battery for operation.

It is an object of the present invention to provide a vehicle monitoring system that can be used to monitor the operational state of vehicles lacking an on board diagnostics port.

It is another object of the present invention to provide a vehicle monitoring system that can change the operational state of vehicular electronics systems.

It is another object of the present invention to provide a vehicle monitoring system that forwards collected data to a three dimensional mapping software or program.

It is another object of the present invention to provide a vehicle monitoring system that forwards collected data to a remote web server.

It is still another object of the present invention to provide a vehicle monitoring system that monitors the voltage load changes of at least one vehicle battery. It is still another object of the present invention to provide a vehicle monitoring system that is used to assess vehicle health and operating condition.

### BRIEF DESCRIPTION OF THE DRAWINGS

FIG. 1 is a flow chart illustrating the data collection and interpretation according to one embodiment of the present invention.

FIG. 2 is a flow chart illustrating a method of use according to one embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The invention generally relates to a monitoring system that can simply retrofit virtually any vehicle to permit the collection of data. There are two main components of the system as a whole. There is: 1) a monitoring apparatus and 2) a wireless device. The monitoring apparatus may have an appearance similar to a key fob or dongle that contains any number of sensors, batteries, memories, processors, and the like therein. The monitoring apparatus plugs preferably into a receptacle in the automobile such as a cigarette adapter or universal serial bus port. A wireless communication transceiver, preferably Bluetooth® enables communication with another wireless device.

The wireless device is preferably a cellular phone although may be any number of wireless devices such as a smart watch, PDA, laptop computer, desktop computer, multimedia player, gaming system, and the like. To enable data transfer between the monitoring apparatus and the wireless device the two system components must be kept within operational or communicative distance which may be constrained by the wireless communication protocol employed. Typically this requires the wireless device to remain in the vehicle as the vehicle is being monitored. Due to this interaction, a number of calculations can be stored, off loaded, downloaded, and monitored/interpreted in real time and thereafter as necessary. Further, the system can log and make changes to operating systems of the vehicle due to contained logic or algorithms stored within either the monitoring apparatus or wireless device.

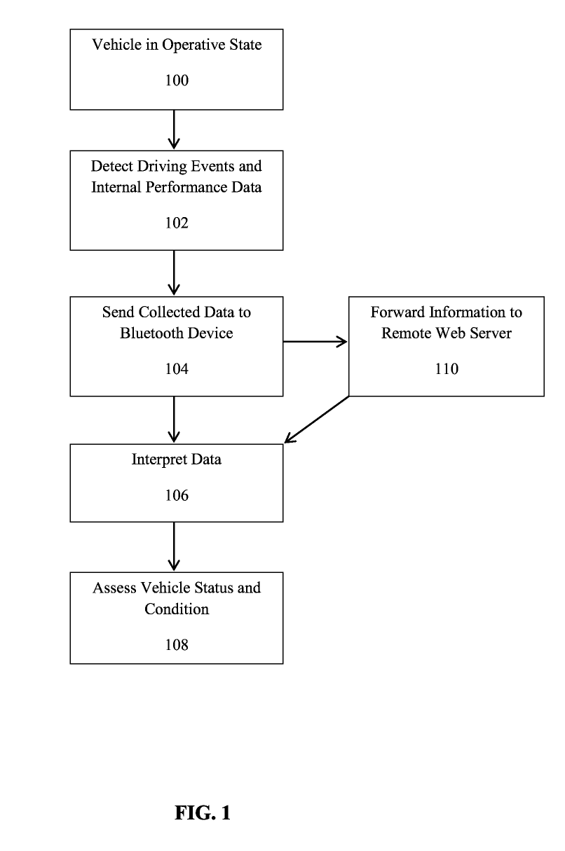

Referring now to FIG. 1, there is a flowchart that illustrates the data collection and interpretation process of a preferred embodiment of the present invention.

In step 100, a vehicle in both an operative state and in some instances a “stand by” state allows for data collection to occur. Such a “stand by” state may be when the vehicle is parked and running or turned off but with the monitoring apparatus still operably coupled to the vehicle.

It is important to note that the vehicle or automobile in question may be any number or user driven or autonomous vehicles including but not limited to passenger cars, trucks, forklifts, backhoes, and unmanned vehicles or UAVs.

In step 102, the vehicle monitoring apparatus detects driving events and internal performance values of the vehicle. This is achieved by at least the apparatus' internal global positioning system transceiver, digital compass, accelerometer, and digital gyroscope and various environmental sensors. Each of these components is capable of collecting innumerable values for each of these variables which includes data critical to the monitoring of a vehicle.

The global positioning system (GPS) permits any interaction with any of the GPS satellites in orbit. These signals contain the time the signal was transmitted, and the satellite position at the time of transmission. From this data, the internal GPS receiver can deduce the position of the object associated with the GPS receiver. In some instances, it may be possible for only three satellite connections instead of the typical four to be made, but this requires an outside known, fixed variable not normally associated with automobile traffic.

The digital compass, accelerometer and gyroscope all provide more detailed data than the GPS receiver. Whereas the GPS provides general location and movement, these components can provide information such lateral gravitational forces (i.e. automobile swerving on road) and other forces and changes of direction (i.e. braking) experienced by the automobile. Additionally, these components can provide a similar read out to replace the GPS feature if the vehicle is in a location where there is not a sufficient GPS satellite coverage (i.e. tunnels, mountainous areas, etc.).

The monitoring apparatus, as noted, may also contain a number of different environmental sensor combinations including but not limited to carbon dioxide, light, temperature, humidity, sound, and the like. These sensors can monitor both the internal or external environment of the associated vehicle. Such sensors may be employed in a number of fashions and combinations to provide data as it relates to the health and operating condition of the vehicle.

Additionally, the system as a whole may monitor the vehicle's battery or batteries for direct current voltage load changes. A “direct current voltage load change(s)” refers to the change in voltage experienced by a direct current battery employed in an automobile or vehicle as a result of a load imparted on the circuit. For example, an automobile may have a number of electrical systems and components such as DVD or other multimedia players, air conditioning, radio, lighting, and the like or any combination thereof. As these electronics are turned on/off the change in voltage across the system as a whole is measured. The monitoring system logs these changes to determine cycle times for turning load bearing electronics on/off.

This can be accomplished in at least two ways. In one embodiment, the monitoring system has a memory which stores certain values prescribed to the system as a whole. Thus, the system can measure and subsequently store values (as related to changes in voltage) of various electronic systems as these systems are turned on/off. When the voltage drop is such that it enters a predetermined range of “caution” or “danger,” which signifies potential damage or electronics failures, the system can automatically via stored logic turn on/off certain electrical systems contained within the vehicle. This may be done randomly or may be done on a customizable, via an electronic device or cellular phone, priority listing of the electronic systems/devices contained within the vehicle.

In a second iteration, an alert is generated based on the change in voltage across the battery. The user can then from their smart phone or other electronic device, which is wirelessly coupled to the monitoring apparatus, to view each load and decide which should be turned off or left on to prevent damage to any of the existing systems or to prevent hazardous conditions on the road. This gives the user more control of how exactly the changes to the system electronics are made.

In step 104, the breadth of data prescribed to at least the variables described above is collected, compiled, stored, and time stamped in the onboard memory in the device. It may be preferential in some cases to send and store the data at a remote site such as with a remote server or remote server database. It is then preferably sent to a wireless device (i.e. Bluetooth®, Wi-Fi®, etc.) for viewing, off load storage or downloading, and processing/interpretation.

As stated, the enabled device may also employ Wi-Fi for wireless data communications. Bluetooth® is a wireless communication standard operating in 2.4-2.8 GHz industrial, scientific, and medical (ISM) band, and is managed by the Bluetooth Special Interest Group (SIG). Wi-Fi is the brand name for products using IEEE 802.11 standard for wireless communication. Wi-Fi operates at a higher power than Bluetooth® permitting higher bit rates and a longer range from the base station. Other viable alternatives may include but are not limited to ANT, ZigBee, and various other personal area networks, wide area networks, and local area networks and the like.

A number of electronic device capable of both wireless and wired communication may interact with the system as desired and are capable of receiving the desired off load/download and storage. These devices can include but are not limited to laptops, PCs, PDAs, smart phones, smart watches, media players, digital cameras, and video game systems. The next step is to interpret the data.

In step 106, the interpretation of the data can occur by a remote viewer in real time or may be interpreted after the download from the monitoring apparatus is complete. This can be achieved by loading the various data points into interpretive software capable of employing analytical algorithms and mapping or by a visual/manual inspection of the collected data. This may be achieved using any number of commercially available multi-dimensional mapping software such as three dimensional mapping software which maps along the x, y, and z, coordinate planes.

Alternatively, in step 110, this data can be sent to a remote web server which enables further interpretation and long term storage. Here, the process is similar to that described above, albeit there may be more or less options to interpret and store the data based on the technological capabilities of each method and system employed.

In step 108, with this interpretation having taken place, one can now assess the health and operative status of the vehicle. There are preset parameters for different vehicles and these parameters can then be examined with relation to the collected data points. Differing values between such data can signify operable issues with the vehicle. For example, one may be able to measure the temperature of particular areas of the vehicle. Data points signaling an unusual temperature readout could signal a cooling mechanism is not working correctly or that there is undue friction occurring between moving parts of the automobile. The user may have an option of having an audible alarm emanating from the wireless device or the monitoring apparatus itself if the data points are over a certain threshold in relation to accepted values for such data.

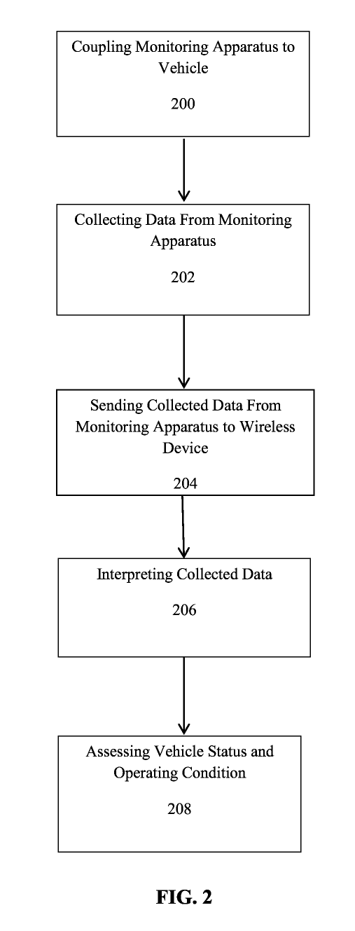

The methodology of applying such a monitoring system is described and illustrated in a flowchart in FIG. 2.

In step 200, the monitoring apparatus is coupled, as described above, to the desired vehicle. The vehicle is typically one that lacks an on-board diagnostics port, however, this is not a requirement. The monitoring apparatus is coupled to the vehicle by preferably using the cigarette adapter or by a universal serial bus connection (USB) port present within the vehicle. Other suitable connections may also be made via any connection which taps into the circuitry of the automobile.

Thus, it is preferable that the monitoring apparatus draws its power from the standard 12-volt battery or other battery system powering the vehicle. This battery power is sufficient to power the monitoring apparatus and to run any variety of programs or wireless protocols stored therein.

In some instances, the device may be able to store energy from the vehicle's battery for use when not physically coupled to the vehicle or when the vehicle is not turned on or the battery has ceased to function. In such embodiments, the monitoring apparatus may have its own internal battery that is charged by the vehicle's battery allowing the monitoring apparatus to continue function after a loss of power if so desired. A simple on/off switch or command received from the wireless device (i.e. cellular phone) may control the operative state of the monitoring apparatus.

In step 202, once the connection or coupling of the monitoring apparatus to the vehicle has been achieved, the monitoring apparatus automatically begins collecting data. These data points can be varied depending on the exact makeup and qualities of the particular apparatus. Preferably, the monitoring apparatus contains a number of programs, algorithms, and the like stored thereon that can assist in the monitoring of the vehicles diagnostics and prognostics. The monitoring apparatus should have at least a digital compass, digital accelerometer, digital gyroscope, carbon dioxide sensor, temperature sensor, humidity sensor, sound sensor, or light sensor, or any combination thereof. The monitoring apparatus may continually collect data points once coupled, or may have a varying level of collection (i.e. every 30 seconds, every minute) which may be manipulated via the monitoring apparatus itself or more preferably via the wireless device communicatively coupled to the monitoring apparatus.

In step 204, the data is sent to a wireless device and is then interpreted or alternatively can be sent to a remote web server from the wireless device for interpretation. The data may be sent to the wireless device in a single packet or the data may be sent concurrently with its collection allowing for monitoring the data collected in real time. Thus, one may be using the wireless device or cellular phone to monitor the vehicle as the data is being collected. In some instances, commands may be sent to the monitoring apparatus as the data is being collected, received, and monitored.

The commands may vary but can include the turning on/off of vehicle electronics, changing the data points or frequency of data points to be collected, turn sensors on/off, and the like. In some instances, the monitoring apparatus may be able to make such changes and influences depending on the programs stored thereon. It is preferable that the monitoring apparatus contains some logic that allows for interpretation of the data collected. If the values of the data collected are such that the monitoring apparatus via stored programs or algorithms recognize a problem with the vehicle, then the monitoring apparatus can respond appropriately whether it's by influencing or changing a vehicle system or sending an alert to the wireless device.

In step 206, notwithstanding the above, the interpreting of the data may be accomplished via the input of the data points into commercially available three dimensional (3-D) mapping software. This permits the recreation of vehicle behavior through an augmented video, and is a user friendly feature that allows for a visual representation of the data. For example, using the GPS data and data collected by various other sensors can allow an appropriate program to recreate the path of the vehicle.

The augmented video can then be created by the program in order to supply a three-dimensional augmented video rending (i.e. virtual reality) of the traveled environment and terrain. The exact video may not reflect every detail of the traveled path as it is merely a recreation, but should supply an accurate representation of vehicle behavior based on the collected data. One can then view a complete augmented path of the vehicle whether they were present in the vehicle at the time of collection or not. This can be key in diagnosing and understanding the collected values and removing false alerts based on the path of travel at that time. Further this can be used by employers to monitor employee behavior in employer owned vehicles and by parents who wish to monitor their children's driving habits. In some instances, this augmented video may be able to be created and monitored in real time. However, this is largely dependent on the system specifications and communication methods being employed.

In step 208, once the augmented video rending has been completed, one can adequately assess the vehicle status and condition. For example, the sound sensor may have collected an irregular reading from the engine which can then be overlaid with the reconstructed data to determine that this occurs during acceleration of the vehicle. This enables a skilled artisan to pinpoint or ascertain the cause or source of the sound.

In another example, it may be seen via an accelerometer that the vehicle is having issues braking when going down a hill. Various factors can be checked to determine if the payload was too high or if the brakes themselves are defective or beginning to fail. The implementation of such collected data overlaid into an augmented video gives mechanics and the like a thorough and complete view of the problems and can be used to help even a layman diagnose and cure any possible issue or have the issue solved by a mechanic before it manifests into a much more serious problem.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A monitoring system for a vehicle capable of being user controlled, the monitoring system comprising:
a monitoring apparatus operably connected to the vehicle, the monitoring apparatus having a digital compass, digital accelerometer, digital gyroscope, global positioning system and at least one environmental sensor,
wherein the at least one environmental sensor consists of a carbon dioxide, temperature, humidity, or light sensor, or any combination thereof,
wherein the vehicle lacks an on-board diagnostics port; and
a wireless device having wireless communication capabilities contained within a predetermined proximity to the monitoring apparatus,
wherein the wireless device establishes a wireless connection with the monitoring apparatus.

2. The monitoring system of claim 1 wherein the monitoring apparatus draws power directly from the vehicle.

3. The monitoring system of claim 1 wherein the wireless device operates off a wireless local area network or wireless personal area network or any combination thereof.

4. The monitoring system of claim 2 wherein the monitoring apparatus plugs into a cigarette adapter.

5. The monitoring system of claim 2 wherein the monitoring apparatus plugs into a universal serial bus port.

6. The monitoring system of claim 1 wherein the wireless device is a smart phone, laptop, PC, PDA, digital camera, smart watch, and video game system or any combination thereof.

7. The monitoring system of claim 6 wherein the wireless device acts as a gateway and forwards collected data to a remote web server.

8. The monitoring system of claim 7 wherein collected data is entered into three-dimensional mapping software.

9. The monitoring system of claim 1 wherein the monitoring system changes the operative state of load bearing electronics of the vehicle by monitoring direct current voltage load changes of at least one battery of the vehicle.

10. A monitoring system for a vehicle capable of being user controlled, the monitoring system consisting of:
a monitoring apparatus operably connected to the vehicle, the monitoring apparatus having a plurality of sensors,
wherein the vehicle lacks an on-board diagnostics port, and
wherein the plurality of sensors are selected from the group consisting of more than one of digital compass, digital accelerometer, digital gyroscope, carbon dioxide sensor, temperature sensor, humidity sensor, sound sensor, or light sensor;
a cellular phone having wireless communication capabilities contained within a predetermined proximity to the monitoring apparatus,
wherein the cellular phone establishes a wireless connection with the monitoring apparatus; and
wherein the monitoring system changes the operative state of load bearing electronics by monitoring direct current voltage load changes of at least one battery of the vehicle.

11. The monitoring system of claim 10 wherein the cellular phone operates off a wireless local area network or wireless personal area network or satellite or mobile telecommunications technology or any combination thereof.

12. The monitoring system of claim 10 wherein the monitoring apparatus plugs into a cigarette adapter or universal serial bus port.

13. The monitoring system of claim 12 wherein the monitoring apparatus is removably coupled to the cigarette adapter or universal serial bus port.

14. The monitoring system of claim 12 wherein the monitoring apparatus stores electrical energy derived from the vehicle's battery.

15. The monitoring system of claim 14 wherein the cellular phone acts as a gateway and forwards collected data to a remote web server.

16. The monitoring system of claim 15 wherein the collected data is entered into three dimensional mapping software creating an augmented video rendering of the traveled path of the vehicle.

17. A method of monitoring a vehicle employing a monitoring system, the method comprising:
removably coupling a monitoring system to the vehicle forming an operable
connection between the monitoring system and the vehicle,
wherein the vehicle lacks an on-board diagnostics port, and
wherein the monitoring system comprises a plurality of sensors,
a monitoring apparatus having a digital compass, digital accelerometer, digital gyroscope, global positioning system and at least one environmental sensor,
wherein the at least one environmental sensor consists of a carbon dioxide, temperature, humidity, or light sensor, or any combination thereof, and
a wireless device having wireless communication capabilities contained within a predetermined proximity to the monitoring apparatus,
wherein the wireless device establishes a wireless connection with the monitoring apparatus;
collecting data in real time from the plurality of sensors associated with the monitoring system configured to monitor vehicular operations,
wherein the monitoring system changes the operative state of load bearing electronics of the vehicle by monitoring and logging direct current voltage load changes of at least one battery of the vehicle;
sending the collected data from the monitoring apparatus to a wireless device, the wireless device being capable of receiving an electronic signal from the monitoring apparatus;
interpreting the collected data on the wireless device or a separate wireless device via a three dimensional augmented video of the traveled path of the vehicle; and
assessing the operable condition of the vehicle by comparing the collected data to predetermined standards for the vehicle.

18. The method of claim 17 wherein collecting the data is achieved using a wireless device operating off a wireless local area network or wireless personal area network or any combination thereof.

19. The method of claim 17 further comprising the step of:
forwarding the collected data to a remote web server, wherein the forwarding step is done after the collecting step and before the interpreting step.

20. The method of claim 17 wherein the vehicle is a heavy duty truck, bus, or any combination thereof.
